(19) United States
(12) Patent Application Publication
(10) Pub. No.: US 2008/0251733 A1
(43) Pub. Date: Oct. 16, 2008

(54) Multiple waveband millimetre and sub-millimetre wave detection system

(75) Inventor: Rupert N. Anderton, Malvern (GB)

Correspondence Address: NIXON & VANDERHYE, PC, 901 NORTH GLEBE ROAD, 11TH FLOOR, ARLINGTON, VA, 22203, US

(73) Assignee: QINETIQ LIMITED, London (GB)

(21) Appl. No.: 12/078,316

(22) Filed: Mar. 28, 2008

Related U.S. Application Data
(60) Provisional application No. 60/907,610, filed on Apr. 11, 2007.

(30) Foreign Application Priority Data
Mar. 28, 2007 (GB) 0705930

(51) Int. Cl. G01J 1/42

(52) U.S. Cl. 250/394

(57) ABSTRACT

A detection system operable at millimetre or sub-millimetre wavelengths includes detection means adapted to detect radiation at two distinct wavebands, wherein a first waveband is chosen such that it has a relatively high atmospheric absorbency to electromagnetic radiation, and the second waveband is chosen to have a relatively low atmospheric absorbency to electromagnetic radiation. The system is further adapted to take measurements from at least two different regions on a target, and to process the measurements to give an indication that the target contains an object of interest. The processing may comprise comparing measurement differences at a given waveband to reference data obtained from test measurements, or from computer models of targets. The detection system provides the ability to detect objects of interest without the need to provide a millimetric or sub-millimetric image of the target.

This application is claims priority from Great Britain Patent Application No. 0705930, filed 28 Mar. 2007, and claims the benefit of U.S. Provisional Application No. 60/907,610, filed 11 Apr. 2007, the entire contents of each of which are hereby incorporated by reference.

This invention relates to detection systems designed to operate in the millimetre and sub-millimetre wave region, including frequencies up into the low terahertz region. In particular, the invention relates to means for detecting objects of interest that may be concealed, for example, under clothing.

Imaging systems operable at millimetre (MM) wavelengths are gaining acceptance in places such as air and sea ports due to their ability to “see” underneath clothing, and through soft sided vehicles. They also have a lower perceived risk to heath, due to the generally passive nature of the systems and to their use of non-ionising radiation. These imaging systems are often rather large and cumbersome due to the size of the imaging optics used relative to visible wavelength and infra-red systems.

Patent application PCT/GB03/03661 discloses a non imaging sensor system that takes two or more readings from a target and performs a comparison of the readings to provide an indication as to what is present at the target. Typically, the readings will be from differing, possibly overlapping areas of the target, or will be of the same or different areas but at differing polarisations. Differences in return from different readings may be indicative of the presence of an object of interest, such as a metallic or dielectric material. As a non imaging sensor is employed, the system can often be made somewhat smaller than a full imaging system. Such a system will also tend to be simpler and cheaper than a full imaging system. The normal operating mode, i.e. that of taking readings from a relatively small target region allows longer integration times to be used, which increases the system sensitivity.

MM wave systems may be used indoors or outdoors. When used indoors they are frequently used with illumination systems such as those disclosed in Applicant's co-pending patent application WO2005/096013. As room temperature is rather close to body temperature there is often a lack of contrast in images recorded indoors, and the use of illuminators improves this contrast and therefore the resultant image or measurement quality. When used outdoors the sky, which is relatively very cold from a mm wave noise point of view is often used to provide this contrast. The sky is typically at around 50 Kelvin on a clear day at millimetre-wave frequencies with relatively low atmospheric absorption, whereas the earth is at approximately 300K. This large difference significantly reduces the sensitivity requirements of mm wave measurement devices that are used to detect materials that are highly reflective in nature, such as metallic objects. Although this produces a strong contrast, it can suffer the problem of false alarms due to specular reflections from various parts of the target. This could be for example the shoulders or head of a person. This is a particular problem for the non-imaging sensors, as they cannot put the reflection in context with the target as a whole to identify it as such rather than as an object of interest. Non imaging sensors of the type disclosed in PCT/GB03/03661 are usually designed to take readings from two areas on a target, and to compare the readings obtained to look for significant differences. Therefore, the lack of any background data other than as recorded by readings from the two areas results in a particular problem for these sensors.

Systems used outdoors that rely on the sky to provide a high contrast are also often poor when it comes to the detection of non-metallic items. Metallic items will tend to reflect the coldness of the sky, so distinguishing them from the background which will tend to be at either body temperature, or at the temperature of the surrounding scenery.

According to a first aspect of the present invention there is provided a detection system sensitive to radiation at millimetre or sub-millimetre wavelengths or thereabouts, characterised in that the system is adapted to be independently sensitive at both a first wavelength and a second wavelength, the first wavelength having a relatively high atmospheric absorbency, and the second wavelength having a relatively low atmospheric absorbency, and further wherein the system comprises:
first and second detectors adapted to measure radiation from at least two regions on a target at each of the first and second wavelengths;
a processor adapted to process outputs from the detectors without forming an image using the measurements obtained and to compare the processed signals against reference data; and
an indicator to provide an indication to an operator based upon the comparison.

A detection system operable at least two wavelengths each having differing atmospheric absorbency properties, as disclosed herein, enables the system to better distinguish between genuine objects of interest and reflections from the sky or some other source of contrast such as an illuminator.

The detection system is adapted to be able to distinguish measurements taken at the first wavelength from measurements taken at the second wavelength, and to process the results taken from each wavelength independently.

If the detection system according to the present invention is used with an illuminator then preferably the illuminator is adapted such that it does not provide significant illumination at the first wavelength. This may be done by, for example, employing a frequency selective surface that acts to filter out radiation at the first wavelength whilst allowing the passage of radiation at the second wavelength.

Note that references to wavelength herein should not be taken to be a single wavelength, unless the context demands that this is the case. Instead, the term wavelength refers to a waveband about the stated wavelength that broadly shares the properties of the stated wavelength in terms of propagation characteristics in the earth's atmosphere. The waveband may be several GHz wide.

A detection system according to an embodiment of the invention is adapted to take measurements from a target of interest at two different regions on the target, wherein each region is measured at both the first and the second wavelength. The system may be adapted to make successive readings from different regions, A, B, such that a first reading is taken from region A, followed by region B, then back to region A, etc, repeating this measurement pattern. The regions may overlap. Each reading preferably records radiation levels at both the first and second wavelengths simultaneously. The system may be adapted to record the radiation at either or both of the first and second wavelengths at different polarisations. The different polarisations may be plane or elliptic, such as circular polarisations.

The system may be adapted to compare measurements taken at each wavelength with template data previously recorded or generated, to produce a “likelihood” figure that the target contains items of interest. The template data may be generated by measuring targets both with and without an item of interest to produce threshold values. The items of interest may be metallic items, or may be dielectric items. Likelihood figures for both measured wavelengths may be combined by, for example, averaging the likelihood figures from measurements made at each wavelength, to produce an overall likelihood.

The template data may also be generated using electromagnetic modelling techniques, based upon how a target may appear if it were not carrying any metallic or dielectric materials, and on how it would appear if it were. These two conditions can then be used as with the measured test targets described above to assign likelihood figures to real targets.

An embodiment of the invention may also record at three, four, or five different regions on the target, or around ten different regions on the target, without forming an image of the target.

An embodiment of the invention may employ a scanning system, to direct radiation from the plurality of different regions on the target to one or more receivers. An embodiment of the invention may incorporate a separate receiver for each wavelength of interest.

The invention allows a comparison to be done between the measurements taken of a target at the first and second wavelengths. For example, a measurement taken at the second, low absorbency wavelength may show a particularly low reading, indicating that a cold (in terms of mm wave or sub-mm wave noise levels, compared to its immediate background or a reading taken from a different part of the target) region is present on the target. This may be an object of interest. However, should the measurement taken at the first, high absorbency wavelength at the same physical region on the target not also indicate the presence of a colder region (compared to its immediate background or a reading taken from a different part of the target), then it may be assumed that the first measurement is of a reflection of the sky from the body rather than from an object of interest. This is because the sky has no contrast to the background at the first wavelength, due to atmospheric absorption making the sky appear warm.

An embodiment of the system is advantageously adapted to have sufficient sensitivity when operating at the first wavelength to distinguish noise temperature differences of only a few Kelvins. Non metallic objects such as dielectric materials, which are not particularly reflective, are more likely to be seen at the first wavelength. This is because if there is no contrast from the sky, the human body is effectively at a uniform radiation temperature and so objects of low contrast will be easier to see, i.e. the signal to clutter ratio will be higher. These objects may be close in temperature to the target, such as a human body, but are likely to be slightly cooler due to the cooling effect of the surrounding environment. This temperature difference is not great however, leading to the preference for high sensitivity.

Detection systems operable at the first wavelength alone may suffer problems which, in the present invention may be ameliorated with measurement information taken at the second frequency. Such problems include false alarms from benign objects. These include objects such as wallets or books that may be in a pocket, and which will block to some extent the radiation being emitted from a warm body. They will therefore tend to be distinguishable from the greater target area as recorded by a measurement of a different region on the target, and may show up as a false alarm. However such objects will tend not to reflect the sky very much and so will tend not show up at the second frequency.

This method of suppressing false alarms is best suited for when the sensor is deliberately adjusted, by setting appropriate thresholds for each wavelength to look only for objects with metallic content.

The system is preferably adapted to take measurements substantially simultaneously at both the first and the second wavelength from a given part of the target. This will eliminate errors due to a change in either the target or the surrounding illumination characteristics between measurements. Measurements taken in quick succession, relative to movements of the target or changes to the surroundings will normally be sufficient to prevent such errors however.

An embodiment of the invention may have an antenna system comprising an antenna array, a horn, or an optical system comprising dielectric, refractive or reflective lenses. The optical system may be common to each of the first and second wavelengths. Alternatively, the system may incorporate separate optical systems for each wavelength, or may share certain optical components for some of the optical paths of each wavelength. The optical system may comprise any suitable combination of lenses, mirrors, and other optical components. The system may incorporate a beam splitter to separate radiation of differing wavelengths. The beam splitter may separate the wavelengths on the basis of polarisation, or may use a frequency selective surface to reflect wavelengths of the first wavelength, and to pass wavelengths of the second wavelength, or vice versa. This has the advantage that multiple polarisations may be received at each wavelength to provide additional discrimination means. The design of such frequency selective surfaces is known. See for example the book “Frequency Selective Surfaces”, by Ben A Monk, John Wiley, 2000. Note that the term “optical” does not mean necessarily that it is operative at visible wavelengths, but instead that it uses optical principles analogous to those commonly applied at visible wavelengths. The use of optics at millimetre and sub-millimetre wavelengths is known.

The wavelengths are preferably chosen such that the atmospheric absorption at the first wavelength is of the order 10 dB/km or greater, such as 15 dB/km, such as 20 dB/km, and the atmospheric absorption at the second wavelength is of the order 2 dB/km or less, such as 1 dB/km or less.

The first wavelength may correspond to a frequency in the band centred on 66 GHz, 183 GHz 325 GHz or 410 GHz, or at any other relatively high absorbency wavelength. The second wavelength may correspond to a frequency in the band centred on 35 GHz, 90 GHz, 140 GHz, 220 GHz or 360 GHz, or at any other relatively low absorbency wavelength.

A system that incorporates dual frequency measurement as described herein also has additional flexibility in operation under certain conditions. For example, if a human target is wearing particularly thick clothing, which tends to get more opaque as the wavelength decreases, then the longer wavelength, be it at the first or second wavelength, may be used exclusively to provide an indication as to the status of the target. If a longer range is required for some reason, then it may be advantageous to use the shorter wavelength which will have a better resolution for a given optical aperture.

The system may be adapted to separately distinguish the wavelengths based upon the polarisation of the radiation at the respective wavelengths. Any suitable polarisation may be employed for each wavelength, commensurate with achieving sufficient isolation between wavelengths. A detector arranged to detect the second wavelength may advantageously be arranged to detect only vertical polarisation, as it has been found that false alarms from sky reflections at the second wavelength are lower when vertical polarisation only is detected.

The system may provide to a user an indication of the results of measurements taken at the first and second wavelengths in any suitable form. An indication may be provided separately for each wavelength, or the measurements may be combined in some suitable manner and an indication provided based on the combination. A relatively simple indication may comprise an audible, visual or vibrational indication that a threshold has been passed for one or both of the first and second wavelengths, or of the “likelihood” value, determined by comparing the target with previous measurements or computer models of targets both with and without items of interest. The likelihood value is essentially a measure of how much the present readings correlate with stored reference data. A high likelihood score will be generated if the present target strongly matches stored data of a target carrying items of interest, and conversely a low likelihood score will be generated if the present target strongly matches stored data of a target not carrying any such items. A more complex indication may comprise a visual monitor showing real-time information relating to current or recent measurements. Such an indication is usefully combined with a visible light video image of the target. A display used with or integrated into the detection system may comprise an image of the target recorded with a visible or infra-red camera, onto which is superimposed graphical information relating to the locations on the target from which the system is receiving mm or sub-mm wave radiation.

Likelihood scores may be assigned thresholds that may be set in various ways. One method is to use an upper threshold, which is approximately the detector output typically produced by an object of interest being present (i.e. a high likelihood score), and a lower threshold, which is approximately the detector output typically produced when NO object of interest is present (i.e. a low likelihood score). Then a full alarm is generated if the detector output is above the upper threshold, no alarm is generated if the detector output is below the lower threshold, and an intermediate alarm condition is generated if the detector output is between the lower and upper thresholds, with alarm level increasing the nearer the output is to the upper threshold compared to the lower threshold. Alternatively a simple on/off alarm may for instance be generated with an alarm signal being given if the detector output is above the half-way point between the upper and lower thresholds.

The thresholds may be altered for different weather conditions and ambient temperature. The detection system may advantageously incorporate a measurement system designed to measure the sky radiometric temperature, particularly at the second, low absorbency wavelength, where variability due to changing cloud cover etc can change the contrast in the target as observed by the detection system. The sky measurement may form a parameter used in selecting or modifying stored data used in the generation of the likelihood scores, or may amend thresholds set in relation to those scores.

An embodiment of the system may incorporate a calibrator capable of providing a calibration signal covering both wavelengths of interest. The calibrator may comprise a “hot” source such as a piece of radiation absorbent material (RAM) attached to a temperature modifying element. This may conveniently be a heating element, although a cooling element, such as a Peltier cell, or a liquid nitrogen based cooler, may also be used. Alternatively, the calibrator may comprise one or more electronic sources of noise power at the first and second wavelengths. The calibrator may be arranged to periodically enter the field of view of the detector system, so providing a hot calibration signal which may be measured at both the first and the second wavelength. An antenna on the detector system may be arranged to physically tilt towards the calibrator, or the calibrator may itself be arranged to move into the field of view of the detector. An embodiment of the invention may be arranged to exclude external radiation (e.g. radiation from a target of interest) during calibration, to prevent extraneous radiation from corrupting the calibration process.

According to a further aspect of the present invention there is provided a method of detecting an object of interest in a target region comprising the steps of:
measuring electromagnetic radiation from at least one point on the target at a first wavelength, the first wavelength being a millimetric wavelength or thereabouts, and having a relatively high atmospheric absorbency;
separately measuring electromagnetic radiation from at least one point on the target at a second wavelength, the second wavelength being a millimetric wavelength or thereabouts different to the first wavelength, and having a relatively low atmospheric absorbency;
combining the measurement at the first wavelength with the measurement at the second wavelength to provide an indication as to the presence or otherwise of the object of interest.

The combination may be performed in any suitable manner. For example, measurements taken at each wavelength from a given point on the target may be thresholded, and the results logically ANDed together.

The measurements may be taken using any suitable millimetric or sub-millimetric (or thereabouts, including frequencies up into the low terahertz region) detection system adapted to record measurement at each of the first and second wavelengths separately, and wherein the information recorded at these wavelengths is not used in the creation of an image. The added complexity of imagers makes them much more expensive, and the present invention is able to carry out much of the functionality of an imager without this additional complexity, making it a simpler and cheaper option.

According to a second aspect of the present invention there is provided a method of detecting an object of interest in a target region comprising the steps of:
measuring electromagnetic radiation from at least a first and a second region on the target at a first wavelength, the first wavelength being a millimetric or sub-millimetric wavelength or thereabouts, and having a relatively high atmospheric absorbency;
measuring electromagnetic radiation from at least the first and the second regions on the target at a second wavelength, the second wavelength being a millimetric or sub-millimetric wavelength or thereabouts different to the first wavelength, and having a relatively low atmospheric absorbency;
combining the measurement at the first wavelength with the measurement at the second wavelength to provide an indication as to the presence or otherwise of the object of interest without forming an image of the target using the measurements.

The method may also produce for each of the received first and second wavelengths, a difference signal, the difference signal comprising the difference in measurements between the first and second regions.

The method may additionally compare the difference information to reference data taken from various targets both containing an object of interest and not containing an object of interest, to produce a likelihood value that the target contains an object of interest.

The invention will now be described in more detail, by way of example only, with reference to the following Figures, of which:

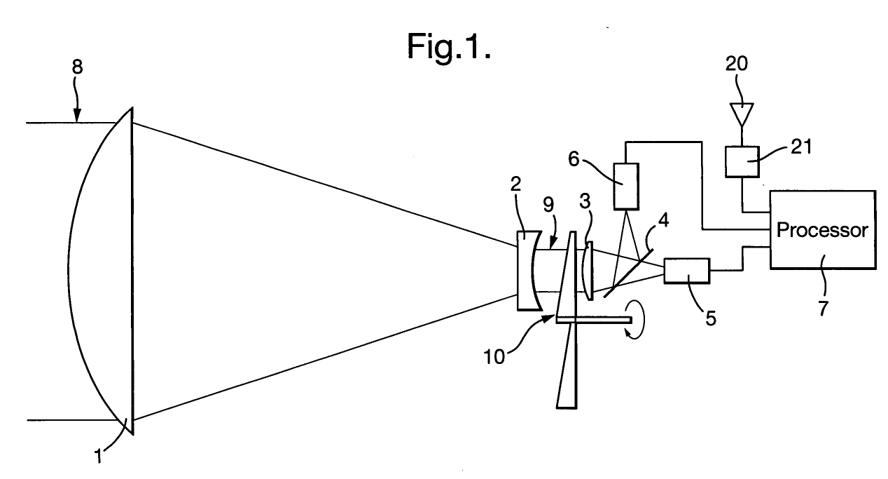

FIG. 1 diagrammatically illustrates a first embodiment of a passive mm wave detection system operable at two different wavelengths according to the present invention, the detection system being a non-imaging detector;

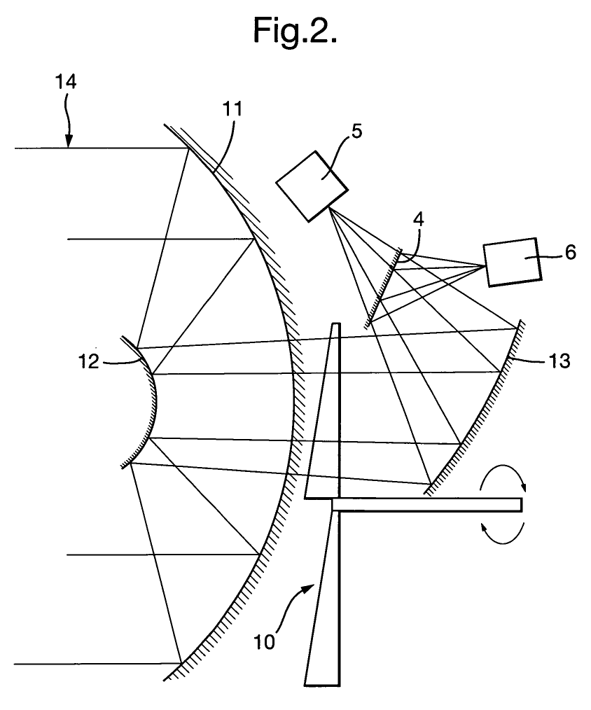

FIG. 2 diagrammatically illustrates a second embodiment of the present invention, functionally similar to the first embodiment, but instead employing reflecting optics; and

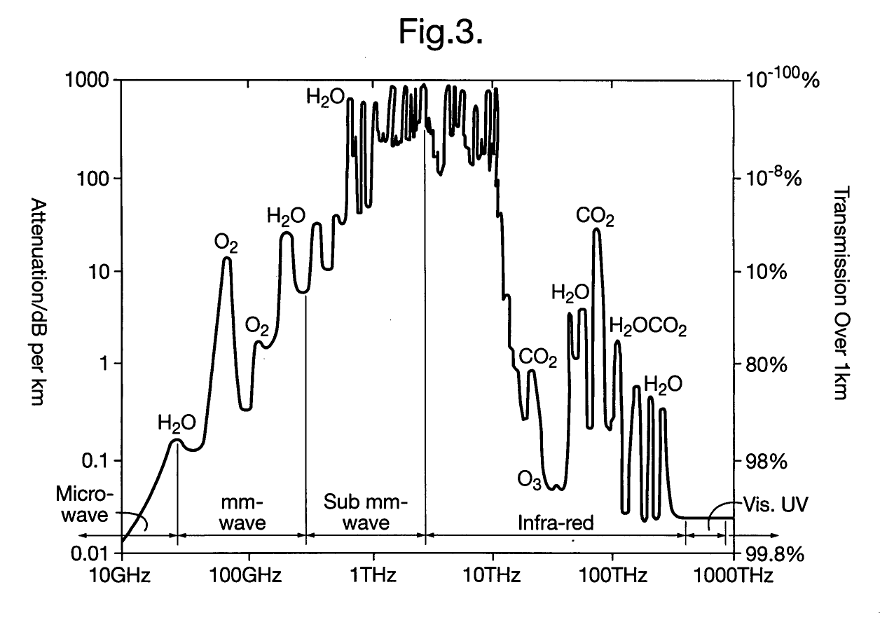

FIG. 3 shows a graph of atmospheric absorbency against frequency for electromagnetic radiation.

FIG. 1 shows a first embodiment of the present invention wherein an optical system comprises a front, convex lens 1, a central concave lens 2 and a rear convex lens 3. A polarising grid, functioning as a beam splitter is located behind rear lens 3, although this could be replaced with a suitable frequency selective surface. A first receiver/detector 5, having relatively high sensitivity to radiation at a first wavelength is positioned to receive radiation passing through polarising grid 4, and a second receiver/detector 6 having relatively high sensitivity to radiation at a second wavelength positioned to receive radiation reflected by polarising grid 4. The first wavelength is chosen such that EM waves at that wavelength have a relatively high atmospheric absorbency, and the second wavelength is chosen such that EM waves at that wavelength have a relatively low atmospheric absorbency. Note that the polarising grid could also be replaced with a partially reflecting, e.g. 50% reflecting mirror if there is sufficient selectivity or filtering in the receivers/detectors to prevent unwanted radiation from being detected. The outputs of receivers/detectors 5 and 6 are fed to processor 7. A scanning mechanism 10 comprising a rotatable prism is positioned between the central lens 2 and the rear lens 3. A sky meter comprising a receive horn 20 and a detector 21 is adapted to measure the radiometric temperature of the sky at the second wavelength and to feed the result to the processor 7.

In operation radiation 8 at both the first and the second wavelengths emanating from a target (not shown) passes through the first 1 and second 2 lenses, producing a narrow parallel beam 9. This beam 9 is deflected by prism 10, which effectively selects a region of interest on the target. The beam 9 then passes through rear lens 3 to polarising grid 9. Radiation having a vertical polarisation is reflected by polarising grid 4 and detected by detector 6, which is arranged to be sensitive to radiation at the second, low absorbency wavelength. Radiation having a horizontal polarisation passes through the polarising grid 4 and is detected by detector 5 which is arranged to be sensitive to radiation at the first, high absorbency wavelength. Prism 10 is a rotatable prism that has two distinct optical characteristics depending upon its instantaneous position. For one half of its rotational period the prism is adapted to deflect energy from a lower region on the target, to the detectors and in the other half it deflects energy from an upper region on the target to the deflectors. Thus it implements a discrete scanning mechanism as it rotates, and the detectors 4, 5 are adapted to provide independent measurements from each scanned region. The outputs from detectors 4 and 5 are processed as described herein using processor 7 to determine whether an object of interest is present. Alternative embodiments may provide the outputs of detectors 4 and 5 independently to an operator for manual evaluation.

The outputs of a given detector comprise separate measurements taken from an upper and a lower region of the target, due to the scanning action of prism 10. For each detector, and hence for each of the first and second wavelength, these measurements are subtracted to form a difference. These differences, one for each wavelength, are then compared with stored reference data as described herein to produce a likelihood score, with the reference data being selected according to the measurement from the sky meter. The likelihood scores for each wavelength are then combined by calculating the average of the two. This results, in this embodiment, with a score running from 0 to 10, and this value is displayed in the form of a dynamic bargraph. For the convenience of an operator, the bargraph is also colour coded depending upon its value. As the score gets higher the graph changes colour from green, through yellow and finally to red. Thresholds may be applied to the likelihood score to initiate alarms or other such indications.

Other ways of processing the outputs of the detectors may be used. For example, binary values may be assigned to the detector outputs according to whether they are above or below a predetermined threshold, and to logically AND the result. Thus, if both detector 4 AND detector 5 receive signals above a threshold then an alarm indicative of the presence of an object of interest may be set.

FIG. 2 shows a second embodiment of the present invention, this time employing reflective optics instead of the refractive optics of the first embodiment. Detectors 5 and 6, beamsplitter 4 and prism 10 are similar to correspondingly numbered elements described in relation to the first embodiment above.

A Cassegrain mirror arrangement comprises a primary, concave reflector 11 and a secondary, convex reflector 12. A third mirror 13 is located behind the Cassegrain arrangement. Incoming energy 14 from a selected direction is reflected from primary mirror 11 onto secondary mirror 12. This reflects the energy through a hole in primary mirror 11 through prism 10 and onto the third, focusing mirror 13. The energy is then directed through beamsplitter 4 and comes to a focus at detectors 5 and 6. The selected direction is determined according to the instantaneous position of prism 10, as in the first embodiment. The beamsplitter 4 may be a polarising grid, a semi-reflective mirror, or a frequency selective surface. The detectors 5 and 6 are, as described in relation to FIG. 1, each primarily sensitive to electromagnetic radiation at one of a first and second wavelength, the first wavelength having a relatively high atmospheric absorbency, and the second wavelength having a relatively low atmospheric absorbency.

A sky meter (not shown) may be employed in similar fashion to that shown in relation to embodiment 1.

Other optical arrangements, e.g. employing an offset curved mirror, will be apparent to the normally skilled person.

As an alternative arrangement, the prism 10 could be removed if desired, and the direction of arrival of the radiation selected by appropriate movement of the third mirror. Other scanning methods will be apparent to the normally skilled person.

As with the first embodiment, the outputs from detectors 4 and 5 are provided to a computer which can then process the detector outputs to record the signal levels over a time period at both the first and second wavelengths, and to process the recorded information to determine whether there appears to be anything significant present on the target at each wavelength. The computer may be of any suitable type. It may comprise for example a simple microcontroller system located on the system itself, making for a particularly compact system.

FIG. 3 shows a graph of atmospheric transmission and absorption of electromagnetic waves at frequencies between 10 GHz and 100 THz. This shows, in the mm-wave and sub-mm wave regions of the graph significant changes in atmospheric attenuation with frequency. The graph also gives an indication as to the absorption mechanism taking place at some of the more pronounced peaks in the graph. For example, an oxygen atom resonance provides a significant absorption at around 66 GHz.

It will be apparent to the normally skilled user that various modifications and amendments may be made to the embodiments as described whilst remaining within the scope of the invention as claimed. For example, it will be clear to the person having ordinary skill in the art that it will be possible to substitute or re-arrange various optical and electronic components as described whilst remaining within the scope of the invention as claimed. The invention should not therefore be limited in scope to just those embodiments described.

We claim:

1. A detection system sensitive to radiation at millimetre or sub-millimetre wavelengths or thereabouts, characterised in that the system is adapted to be independently sensitive at both a first wavelength and a second wavelength, the first wavelength having a relatively high atmospheric absorbency, and the second wavelength having a relatively low atmospheric absorbency, and further wherein the system comprises:
first and second detectors adapted to measure radiation from at least two regions on a target at each of the first and second wavelengths;
a processor adapted to process outputs from the detectors without forming an image using the measurements obtained and to compare the processed signals against reference data; and
an indicator to provide an indication to an operator based upon the comparison.

2. A detection system as claimed in claim 1 wherein the system comprises an optical system having at least one of a lens and a mirror, and a first detector sensitive to the first wavelength and a second detector sensitive to the second wavelength.

3. A detection system as claimed in claim 1 wherein the system comprises an electrical antenna.

4. A detection system as claimed in claim 1 wherein the at least two regions may overlap.

5. A detection system as claimed in claim 1 wherein the first wavelength is equivalent to a frequency chosen from frequency bands in the region of 66 GHz, 183 GHz, 325 GHz and 410 GHz.

6. A detection system as claimed in claim 1 wherein the second wavelength is equivalent to a frequency chosen from frequency bands in the region of 35 GHz, 90 GHz, 140 GHz, 220 GHz or 360 GHz.

7. A detection system as claimed in claim 1 wherein the system further includes a beam splitter adapted to split received energy into a first and a second path, with the first path associated with the first wavelength, and the second path associated with the second wavelength.

8. A detection system as claimed in claim 7 wherein the beam splitter comprises a semi-reflective mirror.

9. A detection system as claimed in claim 7 wherein the beam splitter comprises a polariser.

10. A detection system as claimed in claim 7 wherein the beam splitter comprises a frequency selective surface.

11. A detection system as claimed in claim 1 wherein the system incorporates an integral calibrator adapted to provide a broadband noise source to the first and second detectors.

12. A detection system as claimed in claim 11 wherein the calibrator comprises thermally controlled radiation absorbent material.

13. A detection system as claimed in claim 10 wherein at least part of the detector is adapted to periodically tilt towards an output of the calibrator.

14. A detection system as claimed in claim 1 wherein a sky meter is incorporated that is adapted to measure the radiometric temperature of the sky at the second wavelength.

15. A detection system as claimed in claim 1 wherein the processor is adapted to produce, for each wavelength, a difference signal comprising the difference in the measurements between the first and second regions.

16. A detection system as claimed in claim 15 wherein the processor is adapted to compare the difference signals to reference data taken from targets both containing an object of interest and not containing an object of interest, to produce a “likelihood” value that the target contains an object of interest.

17. A method of detecting an object of interest in a target region comprising the steps of:
measuring electromagnetic radiation from at least a first and a second region on the target at a first wavelength, the first wavelength being a millimetric or sub-millimetric wavelength or thereabouts, and having a relatively high atmospheric absorbency;
measuring electromagnetic radiation from at least the first and the second regions on the target at a second wavelength, the second wavelength being a millimetric or sub-millimetric wavelength or thereabouts different to the first wavelength, and having a relatively low atmospheric absorbency;
combining the measurement at the first wavelength with the measurement at the second wavelength to provide an indication as to the presence or otherwise of the object of interest without forming an image of the target using the measurements.

18. A method as claimed in claim 17 wherein, for each wavelength, a difference signal is produced, the difference signal comprising the difference in measurements between the first and second regions.

19. A method as claimed in claim 18 wherein the difference information is compared to reference data taken from various targets both containing an object of interest and not containing an object of interest, to produce a likelihood value that the target contains an object of interest.
